(19) United States
(12) Patent Application Publication
(10) Pub. No.: US 2024/0322973 A1
(43) Pub. Date: Sep. 26, 2024

(54) MULTIPLE TRANSMISSION CONFIGURATION INDICATOR STATES FOR SERVING CELLS NOT CONFIGURED FOR SINGLE FREQUENCY NETWORK TRANSMISSIONS

(71) Applicant: QUALCOMM Incorporated, San Diego, CA (US)

(72) Inventors: Ruiming ZHENG, Beijing (CN); Muhammad Sayed Khairy ABDELGHAFFAR, San Jose, CA (US); Yu ZHANG, San Diego, CA (US); Sony AKKARAKARAN, Poway, CA (US)

(21) Appl. No.: 18/579,077

(22) PCT Filed: Oct. 1, 2021
(86) PCT No.: PCT/CN2021/122483

§ 371 Date: Jan. 12, 2024

(51) Int. Cl. H04L 5/00

(52) U.S. Cl. CPC H04L 5/0053; H04L 5/0092

(57) ABSTRACT

Various aspects of the present disclosure generally relate to wireless communication. In some aspects, a user equipment (UE) may receive, from a network, a list of serving cells including a first serving cell that is using a control resource set (CORESET) for single frequency network (SFN) transmissions. Additionally, the UE may receive, from the network, a control element indicating two transmission configuration indicator (TCI) states and associated with the first serving cell and the CORESET. Accordingly, the UE may process the control element based at least in part on determining that one or more additional serving cells in the list are not using the CORESET for SFN transmissions. Numerous other aspects are described.

### FIELD OF THE DISCLOSURE

Aspects of the present disclosure generally relate to wireless communication and to techniques and apparatuses for processing multiple transmission configuration indicator states for serving cells not configured for single frequency network transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors coupled to the memory. The one or more processors may be configured to receive, from a network, a list of serving cells including a first serving cell that is using a control resource set (CORESET) for single frequency network (SFN) transmissions. The one or more processors may be further configured to receive, from the network, a control element indicating two transmission configuration indicator (TCI) states and associated with the first serving cell and the CORESET. The one or more processors may be configured to process the control element based at least in part on determining that one or more additional serving cells in the list are not using the CORESET for SFN transmissions.

Some aspects described herein relate to an apparatus for wireless communication performed at a base station. The apparatus may include a memory and one or more processors coupled to the memory. The one or more processors may be configured to transmit, to a UE, a list of serving cells including a first serving cell that is using a CORESET for SFN transmissions. The one or more processors may be further configured to transmit, to the UE, a control element indicating two TCI states and associated with the first serving cell and the CORESET, wherein the control element is based at least in part on one or more rules associated with the list of serving cells.

Some aspects described herein relate to an apparatus for wireless communication at a UE. The apparatus may include a memory and one or more processors coupled to the memory. The one or more processors may be configured to receive, from a network, a control element indicating one TCI state and associated with a first serving cell and a CORESET. The one or more processors may be further configured to process the control element based at least in part on determining that the CORESET is used for SFN transmissions in the first serving cell and is associated with two TCI states.

Some aspects described herein relate to an apparatus for wireless communication at a UE. The apparatus may include a memory and one or more processors coupled to the memory. The one or more processors may be configured to receive, from a network, a list of serving cells including a first serving cell that is using a CORESET for a first type of SFN transmissions. The one or more processors may be further configured to receive, from the network, a control element indicating two TCI states and associated with the first serving cell and the CORESET. The one or more processors may be configured to process the control element based at least in part on determining that one or more additional serving cells in the list are not using the CORESET for the first type of SFN transmissions.

Some aspects described herein relate to a method of wireless communication performed by a UE. The method may include receiving, from a network, a list of serving cells including a first serving cell that is using a CORESET for SFN transmissions. The method may further include receiving, from the network, a control element indicating two TCI states and associated with the first serving cell and the CORESET. The method may include processing the control element based at least in part on determining that one or more additional serving cells in the list are not using the CORESET for SFN transmissions.

Some aspects described herein relate to a method of wireless communication performed by a base station. The method may include transmitting, to a UE, a list of serving cells including a first serving cell that is using a CORESET for SFN transmissions. The method may further include transmitting, to the UE, a control element indicating two TCI states and associated with the first serving cell and the CORESET, wherein the control element is based at least in part on one or more rules associated with the list of serving cells.

Some aspects described herein relate to a method of wireless communication performed by a UE. The method may include receiving, from a network, a control element indicating one TCI state and associated with a first serving cell and a CORESET. The method may further include processing the control element based at least in part on determining that the CORESET is used for SFN transmissions in the first serving cell and is associated with two TCI states.

Some aspects described herein relate to a method of wireless communication performed by a UE. The method may include receiving, from a network, a list of serving cells including a first serving cell that is using a CORESET for a first type of SFN transmissions. The method may further include receiving, from the network, a control element indicating two TCI states and associated with the first serving cell and the CORESET. The method may include processing the control element based at least in part on determining that one or more additional serving cells in the list are not using the CORESET for the first type of SFN transmissions.

Some aspects described herein relate to a non-transitory computer-readable medium that stores a set of instructions for wireless communication by a UE. The set of instructions, when executed by one or more processors of the UE, may cause the UE to receive, from a network, a list of serving cells including a first serving cell that is using a CORESET for SFN transmissions. The set of instructions, when executed by one or more processors of the UE, may further cause the UE to receive, from the network, a control element indicating two TCI states and associated with the first serving cell and the CORESET. The set of instructions, when executed by one or more processors of the UE, may cause the UE to process the control element based at least in part on determining that one or more additional serving cells in the list are not using the CORESET for SFN transmissions.

Some aspects described herein relate to a non-transitory computer-readable medium that stores a set of instructions for wireless communication by a base station. The set of instructions, when executed by one or more processors of the base station, may cause the base station to transmit, to a UE, a list of serving cells including a first serving cell that is using a CORESET for SFN transmissions. The set of instructions, when executed by one or more processors of the base station, may further cause the base station to transmit, to the UE, a control element indicating two TCI states and associated with the first serving cell and the CORESET.

Some aspects described herein relate to a non-transitory computer-readable medium that stores a set of instructions for wireless communication by a UE. The set of instructions, when executed by one or more processors of the UE, may cause the UE to receive, from a network, a control element indicating one TCI state and associated with a first serving cell and a CORESET. The set of instructions, when executed by one or more processors of the UE, may further cause the UE to process the control element based at least in part on determining that the CORESET is used for SFN transmissions in the first serving cell and is associated with two TCI states.

Some aspects described herein relate to a non-transitory computer-readable medium that stores a set of instructions for wireless communication by a UE. The set of instructions, when executed by one or more processors of the UE, may cause the UE to receive, from a network, a list of serving cells including a first serving cell that is using a CORESET for a first type of SFN transmissions. The set of instructions, when executed by one or more processors of the UE, may further cause the UE to receive, from the network, a control element indicating two TCI states and associated with the first serving cell and the CORESET. The set of instructions, when executed by one or more processors of the UE, may cause the UE to process the control element based at least in part on determining that one or more additional serving cells in the list are not using the CORESET for the first type of SFN transmissions.

Some aspects described herein relate to an apparatus for wireless communication. The apparatus may include means for receiving, from a network, a list of serving cells including a first serving cell that is using a CORESET for SFN transmissions. The apparatus may further include means for receiving, from the network, a control element indicating two TCI states and associated with the first serving cell and the CORESET. The apparatus may include means for processing the control element based at least in part on determining that one or more additional serving cells in the list are not using the CORESET for SFN transmissions.

Some aspects described herein relate to an apparatus for wireless communication. The apparatus may include means for transmitting, to a UE, a list of serving cells including a first serving cell that is using a CORESET for SFN transmissions. The apparatus may further include means for transmitting, to the UE, a control element indicating two TCI states and associated with the first serving cell and the CORESET, wherein the control element is based at least in part on one or more rules associated with the list of serving cells.

Some aspects described herein relate to an apparatus for wireless communication. The apparatus may include means for receiving, from a network, a control element indicating one TCI state and associated with a first serving cell and a CORESET. The apparatus may further include means for processing the control element based at least in part on determining that the CORESET is used for SFN transmissions in the first serving cell and is associated with two TCI states.

Some aspects described herein relate to an apparatus for wireless communication. The apparatus may include means for receiving, from a network, a list of serving cells including a first serving cell that is using a CORESET for a first type of SFN transmissions. The apparatus may further include means for receiving, from the network, a control element indicating two TCI states and associated with the first serving cell and the CORESET. The apparatus may include means for processing the control element based at least in part on determining that one or more additional serving cells in the list are not using the CORESET for the first type of SFN transmissions.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3A is a diagram illustrating an example of single frequency network (SFN) scheme A, in accordance with the present disclosure.

FIG. 3B is a diagram illustrating an example of SFN scheme B, in accordance with the present disclosure.

FIG. 4 is a diagram illustrating an example associated with a list of serving cells for simultaneous transmission configuration indicator (TCI) state configuration, in accordance with the present disclosure.

FIGS. 5A and 5B are diagrams illustrating examples associated with control elements indicating multiple TCI states, in accordance with the present disclosure.

FIG. 6 is a diagram illustrating an example associated with processing multiple TCI states for serving cells not configured for SFN transmissions, in accordance with the present disclosure.

FIG. 7 is a diagram illustrating an example associated with processing a single TCI state for serving cells configured for SFN transmissions, in accordance with the present disclosure.

FIG. 8 is a diagram illustrating an example associated with a list of serving cells for simultaneous TCI state configuration, in accordance with the present disclosure.

FIGS. 9, 10, 11, and 12 are diagrams illustrating example processes associated with processing TCI states for serving cells configured and not configured for SFN transmissions, in accordance with the present disclosure.

FIGS. 13 and 14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

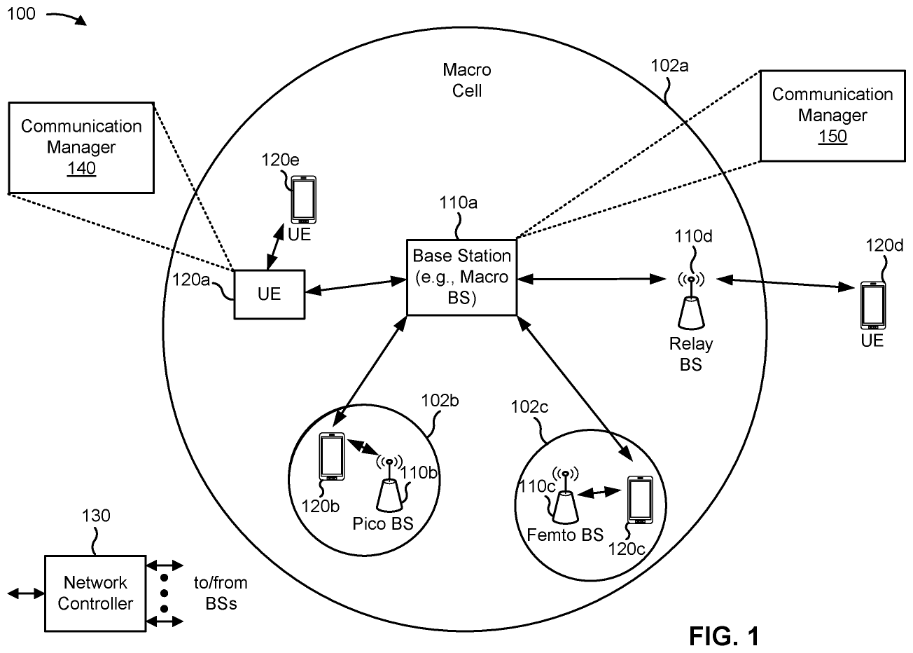

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive (e.g., from the base station 110) a list of serving cells including a first serving cell that is using a control resource set (CORESET) for single frequency network (SFN) transmissions, receive (e.g., from the base station 110) a control element indicating two transmission configuration indicator (TCI) states and associated with the first serving cell and the CORESET, and process the control element based at least in part on determining that one or more additional serving cells in the list are not using the CORESET for SFN transmissions. Additionally, or alternatively, and as described in more detail elsewhere herein, the communication manager 140 may receive (e.g., from the base station 110) a control element indicating one TCI state and associated with a first serving cell and a CORESET, and process the control element based at least in part on determining that the CORESET is used for SFN transmissions in the first serving cell and is associated with two TCI states. Additionally, or alternatively, and as described in more detail elsewhere herein, the communication manager 140 may receive (e.g., from the base station 110) a list of serving cells including a first serving cell that is using a CORESET for a first type of SFN transmissions, receive (e.g., from the base station 110) a control element indicating two TCI states and associated with the first serving cell and the CORESET, and process the control element based at least in part on determining that one or more additional serving cells in the list are not using the CORESET for the first type of SFN transmissions. Additionally, or alternatively, the communication manager 140 may perform one or more other operations described herein.

In some aspects, the base station 110 may include a communication manager 150. As described in more detail elsewhere herein, the communication manager 150 may transmit (e.g., to the UE 120) a list of serving cells including a first serving cell that is using a CORESET for SFN transmissions, and transmit (e.g., to the UE 120) a control element indicating two TCI states and associated with the first serving cell and the CORESET, wherein the control element is based at least in part on one or more rules associated with the list of serving cells. Additionally, or alternatively, the communication manager 150 may perform one or more other operations described herein.

As indicated above, FIG. 1 is provided as an example. Other examples may differ from what is described with regard to FIG. 1.

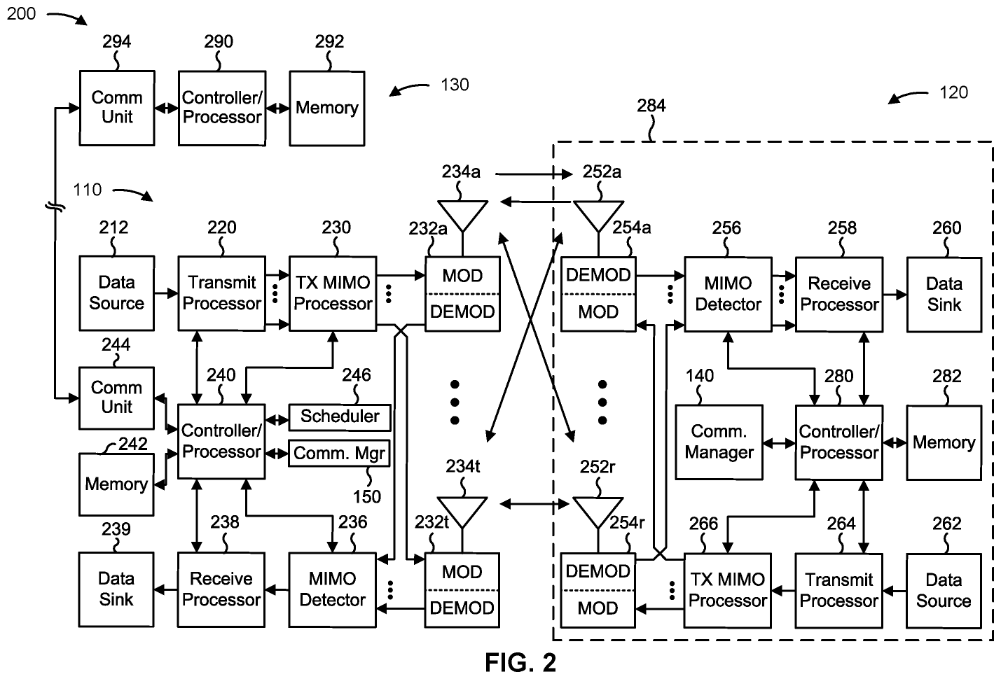

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

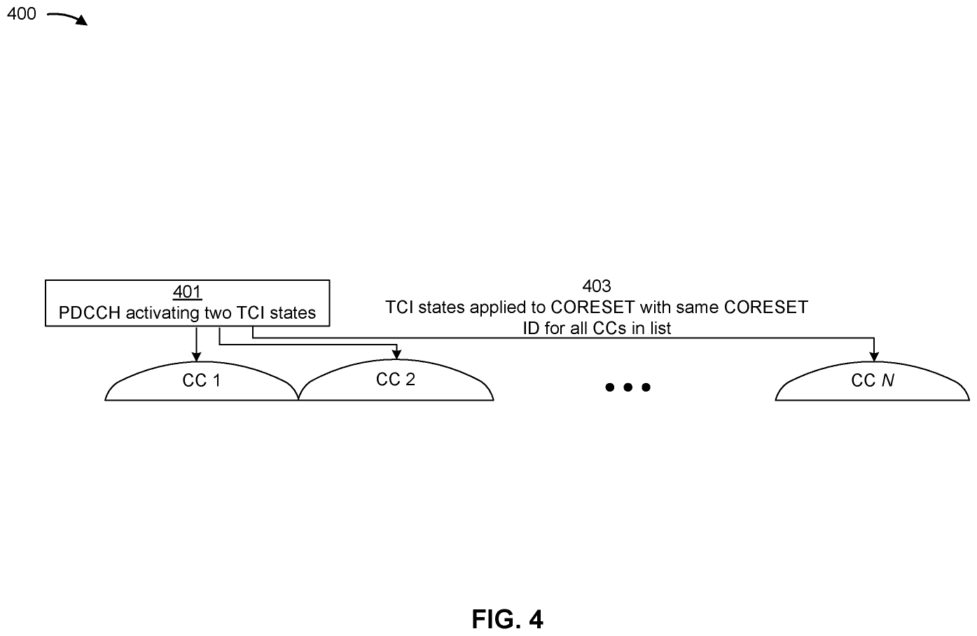

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

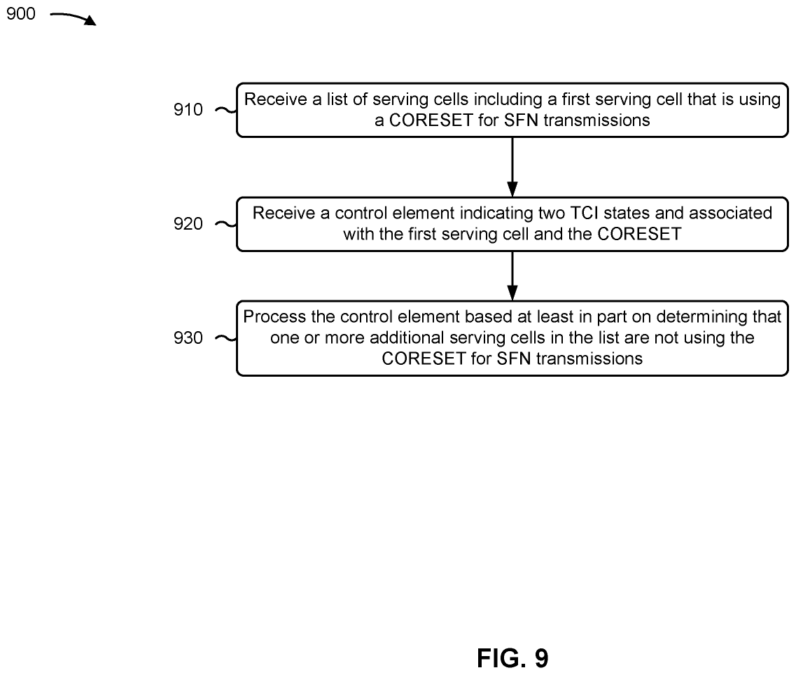

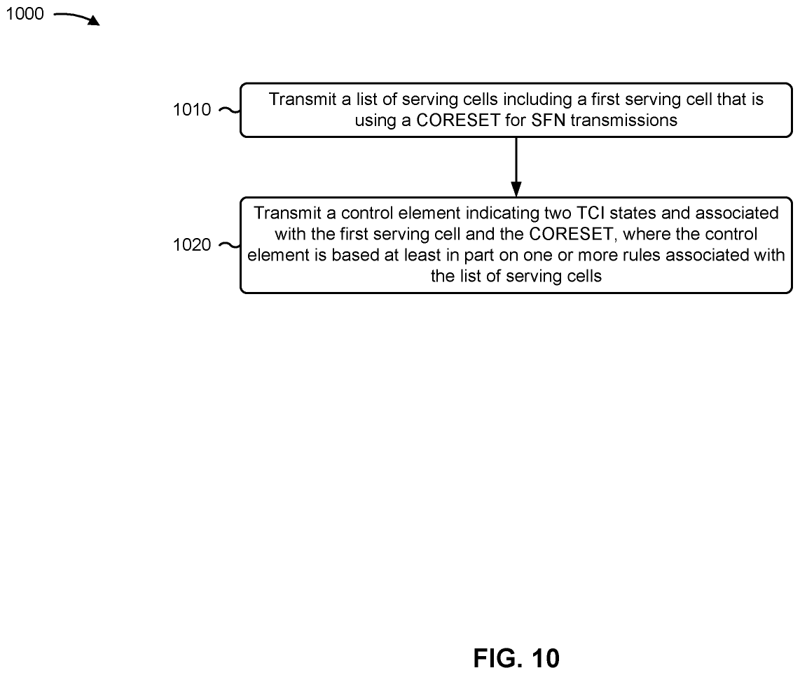

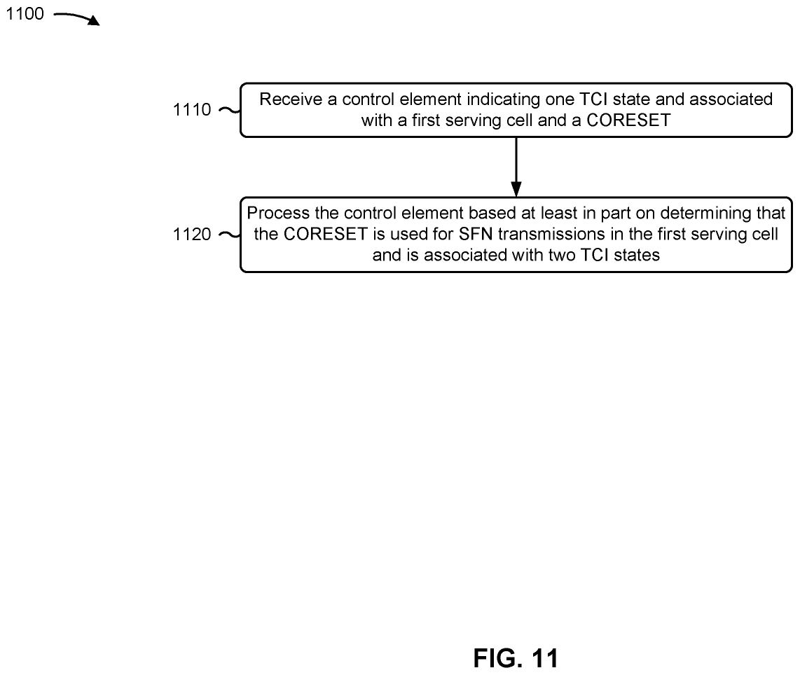

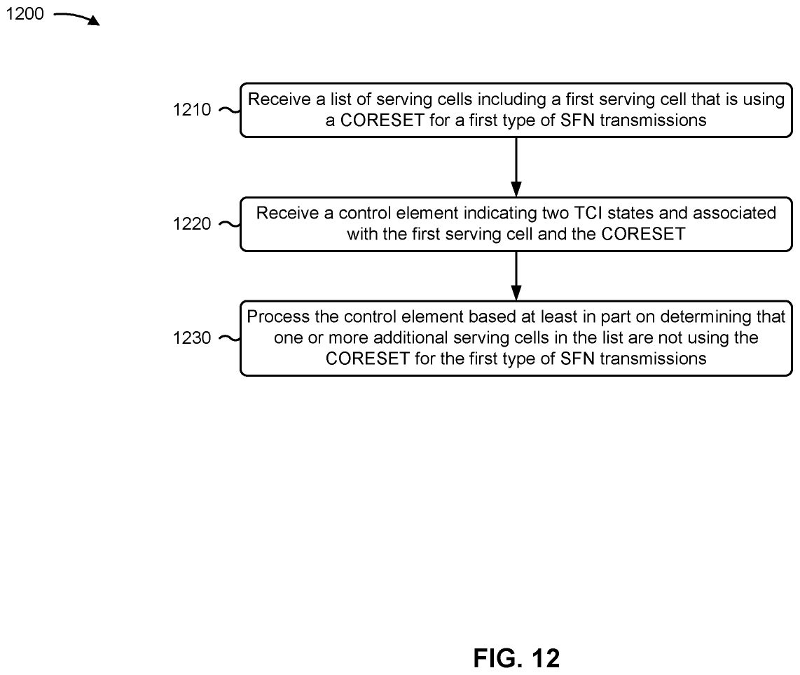

The controller/processor 240 of the base station 110, the controller/processor 280 of the UE 120, and/or any other component(s) of FIG. 2 may perform one or more techniques associated with processing multiple TCI states for serving cells not configured for SFN transmissions, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

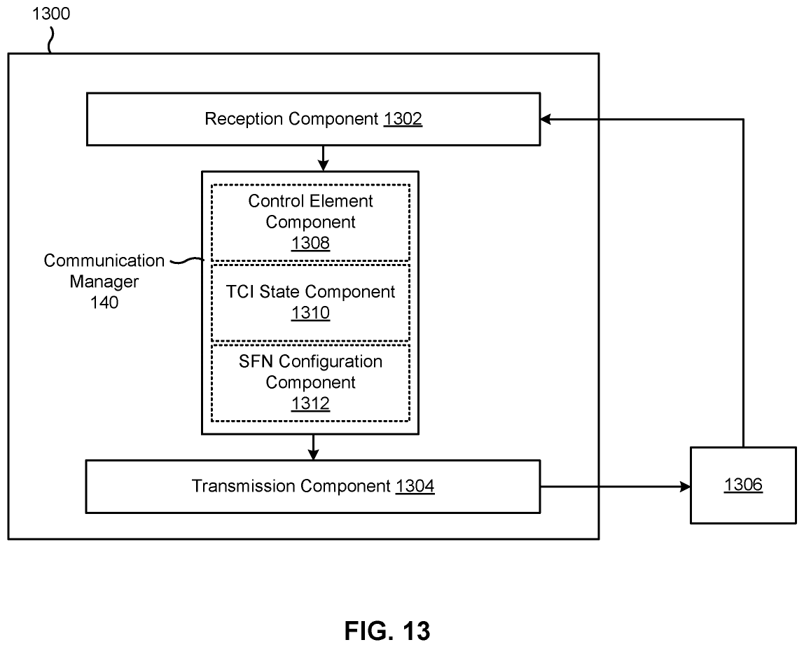

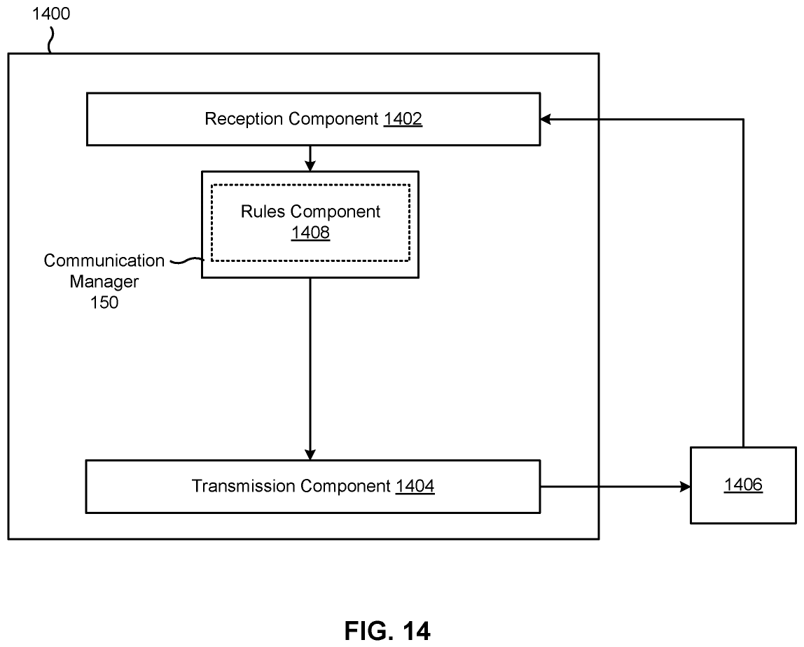

In some aspects, a UE (e.g., the UE 120 and/or apparatus 1300 of FIG. 13) may include means for receiving, from a network (e.g., including the base station 110 and/or apparatus 1400 of FIG. 14), a list of serving cells including a first serving cell that is using a CORESET for SFN transmissions; means for receiving, from the network, a control element indicating two TCI states and associated with the first serving cell and the CORESET; and/or means for processing the control element based at least in part on determining that one or more additional serving cells in the list are not using the CORESET for SFN transmissions. Additionally, or alternatively, the UE may include means for receiving, from the network, a control element indicating one TCI state and associated with a first serving cell and a CORESET; and/or means for processing the control element based at least in part on determining that the CORESET is used for SFN transmissions in the first serving cell and is associated with two TCI states. Additionally, or alternatively, the UE may include means for receiving, from the network, a list of serving cells including a first serving cell that is using a CORESET for a first type of SFN transmissions; means for receiving, from the network, a control element indicating two TCI states and associated with the first serving cell and the CORESET; and/or means for processing the control element based at least in part on determining that one or more additional serving cells in the list are not using the CORESET for the first type of SFN transmissions. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a base station (e.g., the base station 110 and/or apparatus 1400 of FIG. 14) may include means for transmitting, to a UE (e.g., the UE 120 and/or apparatus 1300 of FIG. 13), a list of serving cells including a first serving cell that is using a CORESET for SFN transmissions; and/or means for transmitting, to the UE, a control element indicating two TCI states and associated with the first serving cell and the CORESET, wherein the control element is based at least in part on one or more rules associated with the list of serving cells. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

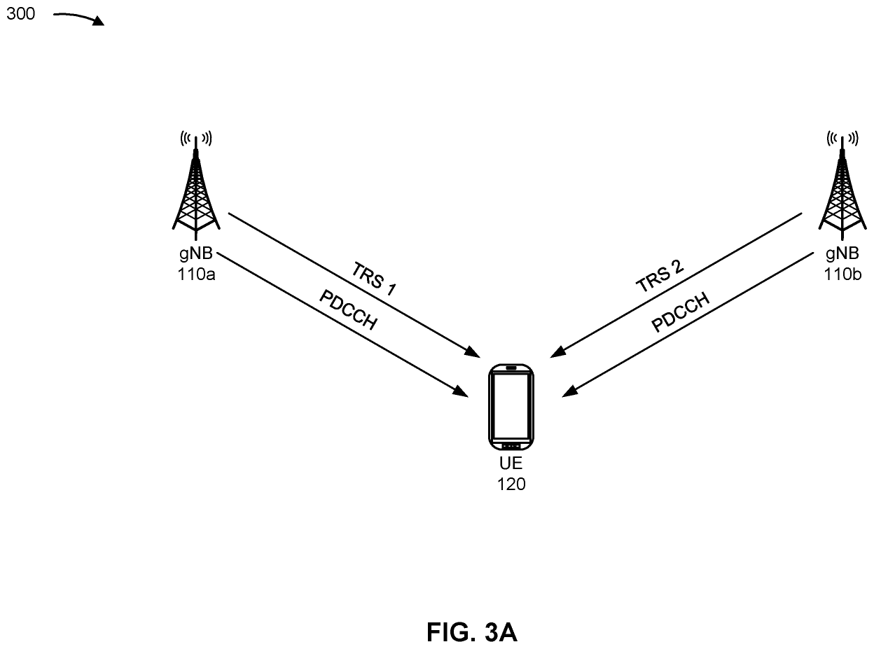

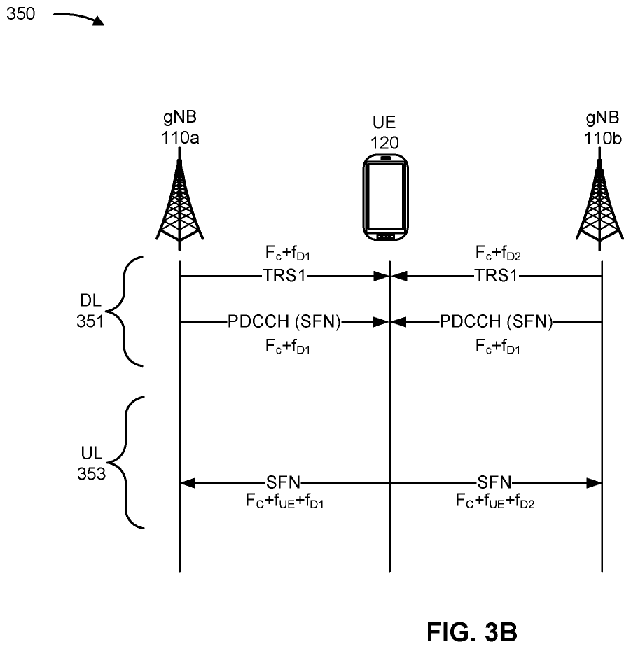

FIGS. 3A and 3B are diagrams illustrating examples 300 and 350 of SFN scheme A and SFN scheme B, respectively, in accordance with the present disclosure. SFN scheme B is also referred to as “TRP-based pre-compensation.”

As shown in FIGS. 3A and 3B, a UE 120 receives downlink communications (e.g., using a physical downlink control channel (PDCCH) and/or a physical downlink shared channel (PDSCH)) from a gNB 110a and a gNB 110b. Because both gNB 110a and gNB 110b transmit the same signal to the UE 120, reliability and quality is improved.

Accordingly, the UE 120 may receive a downlink transmission using a transmission configuration, such as a TCI state (e.g., represented by a TCI-State data structure, as defined in 3GPP specifications and/or another standard). For example, the gNB 110a, the gNB 110b, and the UE 120 may be configured for beamformed communications, where the gNB 110a and the gNB 110b may each transmit in the direction of the UE 120 using a directional BS transmit beam, and the UE 120 may receive the transmissions using a directional UE receive beam. Each BS transmit beam may have an associated beam identifier (ID), beam direction, or beam symbols, among other examples. Additionally, a downlink beam, such as a BS transmit beam or a UE receive beam, may be associated with a TCI state. A TCI state may indicate a directionality or a characteristic of the downlink beam, such as one or more quasi-co-location (QCL) properties of the downlink beam. For example, a QCL property may be indicated using a qcl-Type indicator within a QCL-Info data structure, as defined in 3GPP specifications and/or another standard. A QCL property may include, for example, a Doppler shift, a Doppler spread, an average delay, a delay spread, or spatial receive parameters, among other examples. In some aspects, a TCI state may be further associated with an antenna port, an antenna panel, and/or a TRP. A TCI state may be associated with one downlink reference signal set (for example, a tracking reference signal (TRS) as shown in FIGS. 3A and 3B, a synchronization signal block (SSB) and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). For example, the downlink reference signal may be indicated using a referenceSignal indicator, within a QCL-Info data structure, as defined in 3GPP specifications and/or another standard. In cases where the QCL type indicates spatial receive parameters, the QCL type may correspond to analog receive beamforming parameters of a UE receive beam at the UE 120.

When receiving SFN transmissions from the gNB 110a and the gNB 110b, the UE 120 applies two TCI states, one associated with each gNB. In SFN scheme B, as shown in FIG. 3B, the TCI state associated with the gNB 110b is different than the TCI state associated with the gNB 110b in SFN scheme A. For example, as shown by reference number 351, the gNB 110b pre-compensates the Doppler shift of downlink transmissions (e.g., on a PDCCH and/or on a PDSCH). Accordingly, when a reference signal (e.g., TRS1) from the gNB 110a is associated with a frequency represented by F_{c} that is Doppler shifted by f_{D1}, and a reference signal (e.g., TRS2) from the gNB 110b is associated with the frequency represented by F_{c} that is Doppler shifted by f_{D2}, the gNB 110b may pre-compensate downlink transmissions by ΔF_{TRP}=f_{D1}−f_{D2}, such that downlink transmissions from the gNB 110a and from the gNB 110b are both associated with the frequency represented by F_{c} that is Doppler shifted by f_{D1}. Accordingly, the TCI state associated with the gNB 110b is a different type of TCI state that accounts for the pre-compensation from the gNB 110b.

Similarly, as shown by reference number 353, the UE 120 compensates uplink transmissions to the gNB 110a by the corresponding Doppler shift by f_{D1} and compensates uplink transmissions to the gNB 110b by the corresponding Doppler shift by f_{D2}. Additionally, the uplink transmissions are Doppler shifted by f_{UE} due to mobility of the UE 120.

In order to apply two TCI states for SFN transmissions, a base station may indicate two TCI states in a control element (e.g., a medium access control (MAC) layer control element (MAC-CE) and/or another control element). Additionally, to conserve signaling overhead, the base station may transmit (e.g., via radio resource control (RRC) signaling) a list of serving cells (e.g., a list of IDs associated with one or more serving cells) for which the base station may change TCI states simultaneously. For example, the base station may transmit a simultaneousTCI-UpdateList1 and/or a simultaneousTCI-UpdateList2 data structure, as defined in 3GPP specifications and/or another standard. Accordingly, a UE receiving the control element may apply the two TCI states to a serving cell indicated in the control element along with any other serving cells included in a same list of serving cells that includes the indicated serving cell.

However, the UE cannot process a control element that indicates two TCI states when one or more serving cells, included in the same list of serving cells as the indicated serving cell, are not configured for SFN. Similarly, the UE cannot process a control element when one or more serving cells, included in the same list of serving cells as the indicated serving cell, are configured for a different type of SFN transmissions than the indicated serving cell (e.g., the indicated serving cell is configured for SFN scheme A and the one or more serving cells included in the same list are configured for SFN scheme B). Conversely, when the indicated serving cell is configured for non-SFN transmissions, the UE cannot process a control element that indicates one TCI state when one or more serving cells, included in the same list of serving cells as the indicated serving cell, are configured for SFN.

Accordingly, some techniques and apparatuses described herein enable a UE (e.g., UE 120) to process a control element that indicates two TCI states when one or more additional serving cells, included in a same list of serving cells as a first serving cell, are not configured for SFN. As a result, the UE 120 and a corresponding network (e.g., including base station 110a and/or base station 110b) experience increased reliability and quality of communications. Increased reliability and quality reduces chances of retransmissions, which therefore conserves power and processing resources at the UE 120 and at the network. Similarly, some techniques and apparatuses described herein enable the UE 120 to process a control element that indicates two TCI states when one or more additional serving cells, included in a same list of serving cells as a first serving cell, are configured for a different type of SFN than the first serving cell. As a result, the UE 120 and the corresponding network experience increased reliability and quality of communications. Additionally, some techniques and apparatuses described herein enable the UE 120 to process a control element that indicates one TCI state when one or more additional serving cells, included in a same list of serving cells as a first serving cell, are configured for SFN. As a result, the UE 120 and the corresponding network experience increased reliability and quality of communications.

As indicated above, FIGS. 3A and 3B are provided as examples. Other examples may differ from what is described with respect to FIGS. 3A and 3B.

FIG. 4 is a diagram illustrating an example 400 associated with a list of serving cells for simultaneous TCI state configuration, in accordance with the present disclosure. As shown in FIG. 4, example 400 includes a plurality of component carriers (CCs), each used by a different serving cell to transmit to a UE (e.g., UE 120). Accordingly, the CCs may be used together to increase throughput to the UE 120 via carrier aggregation (CA). Each CC may be associated with a corresponding CORESET. As used herein, “CORESET” refers to one or more frequency and time resources associated with control information transmitted from a network (e.g., via a base station 110a and/or a base station 110b) to the UE 120. Each CORESET may be associated with a corresponding ID, and a same CORESET may be used across serving cells (and thus across CCs) and identified using a same ID.

The network may configure (e.g., via RRC signaling) a list of the serving cells (e.g., a list including serving cell IDs) such that the network may simultaneously update TCI states for a CORESET across the CCs associated with the serving cells on the list. In some aspects, the list may include a simultaneousTCI-UpdateList1 and/or a simultaneousTCI-UpdateList2 data structure, as defined in 3GPP specifications and/or another standard. Additionally, or alternatively, the list may include a new data structure defined in 3GPP specifications and/or another standard.

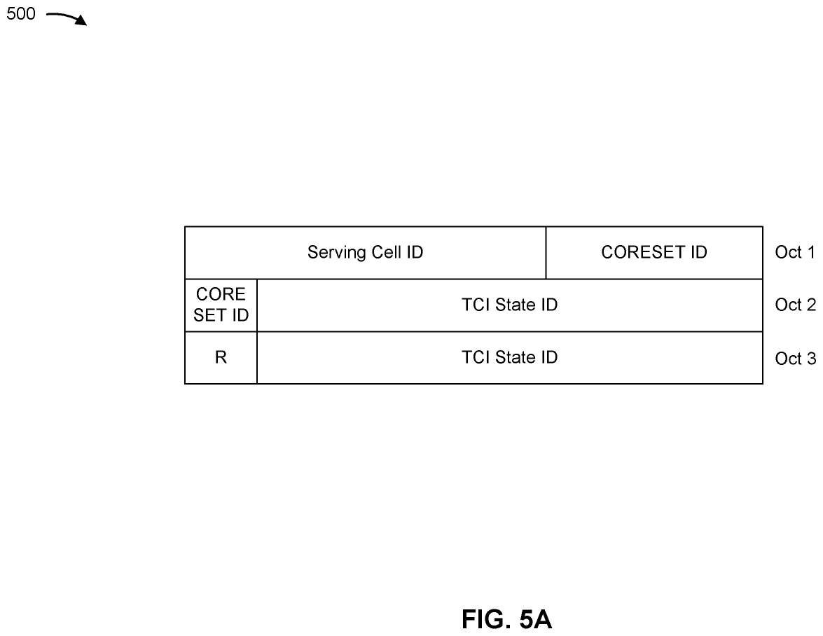

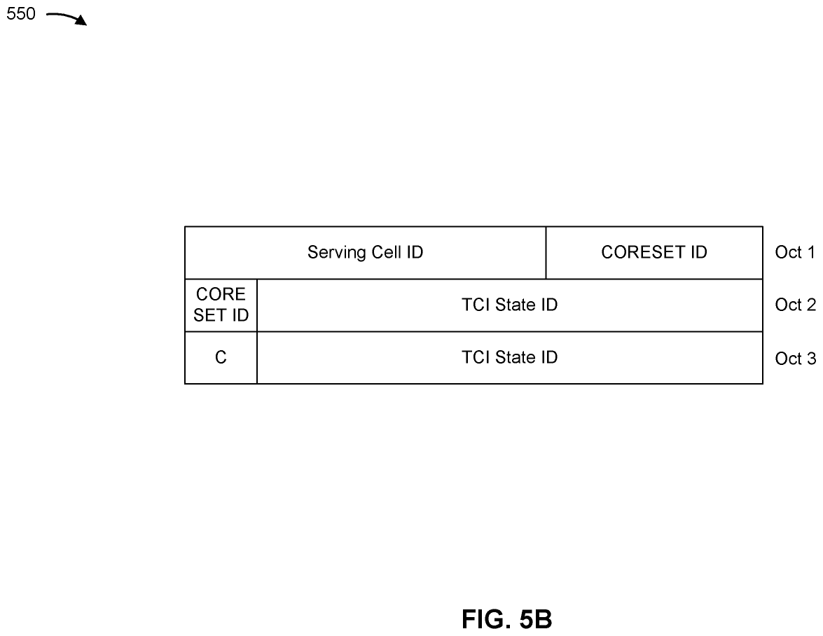

Accordingly, as shown by reference number 401, the network may transmit a control element, such as a MAC-CE, to the UE 120 (e.g., on a PDCCH) that activates two TCI states. For example, the MAC-CE may be structured as described in connection with FIG. 5A or FIG. 5B. The MAC-CE may indicate a CORESET (e.g., using a CORESET ID) such that, as shown by reference number 403, the UE 120 may apply the two TCI states to the CORESET in the serving cells indicated in the list (which may include at least a first serving cell in which the CORESET is configured for SFN and optionally with one or more additional serving cells in which the CORESET is configured for SFN).

The network may apply one or more rules to generate the MAC-CE. For example, the rule(s) may indicate that the list only include serving cells in which the CORESET is configured for SFN transmissions or only include serving cells in which the CORESET is configured for non-SFN transmissions. Accordingly, the MAC-CE includes two TCI states when the CORESET is configured for SFN in all serving cells on the list or includes one TCI state when the CORESET is configured for non-SFN in all serving cells on the list. When some serving cells are configured for SFN scheme A and others are configured for SFN scheme B, the rule(s) may further indicate that the list only include serving cells in which the CORESET is configured for SFN scheme A or only include serving cells in which the CORESET is configured for SFN scheme B, because SFN scheme B uses a different TCI state than SFN scheme A, as described in connection with FIGS. 3A and 3B.

In some aspects, the rule(s) may indicate that the list only include serving cells in which the CORESET is configured for SFN transmissions. For example, the network may use different lists for serving cells in which the CORESET is configured for non-SFN transmissions (e.g., a simultaneousTCI-UpdateList1 and/or a simultaneousTCI-Update List2 data structure, as defined in 3GPP specifications and/or another standard) and for serving cells in which the CORESET is configured for SFN transmissions (e.g., one or more new data structures, as defined in 3GPP specifications and/or another standard).

In some aspects, the rule(s) may additionally indicate that the list only include serving cells in which all CORESETs are configured for SFN transmissions or only include serving cells in which all CORESETs are configured for non-SFN transmissions. Alternatively, the rule(s) may additionally indicate that the list only include serving cells in which at least one CORESET is configured for SFN transmissions or only include serving cells in which at least one CORESET is configured for non-SFN transmissions.

Accordingly, to comply with any of the rules described above, the network may update the list of serving cells based at least in part on CORESETs within the serving cells being configured for SFN transmissions (e.g., SFN scheme A or SFN scheme B) or non-SFN transmissions. For example, the network may use RRC signaling and/or a control element, such as a MAC-CE, to remove a serving cell from the list when the serving cell does not comply with the rule(s). Similarly, the network may also add a serving cell to the list when the serving cell does comply with the rule(s).

The rule(s) can help ensure that the UE 120 can apply the two TCI states indicated in a MAC-CE to the CORESET across all serving cells in the list. However, in some situations, the list may still include a serving cell in which the CORESET is not configured for SFN. For example, the network may transmit the MAC-CE before updating the list of serving cells in an error case. Accordingly, the UE 120 may discard the MAC-CE and not update TCI states associated with any serving cell. As a result, the network and the UE 120 both discard the MAC-CE and use already-activated TCI states for the CORESET across serving cells to communicate.

In another example, the network may be allowed to transmit the MAC-CE with two TCI states even when the list still includes at least one serving cell in which the CORESET is not configured for SFN. Accordingly, the UE 120 may apply the first TCI state or the second TCI state indicated in the MAC-CE (e.g., as described in connection with FIG. 5A) to the CORESET in serving cells on the list for which the CORESET is configured for non-SFN transmissions. As an alternative, the UE 120 may apply a TCI state indicated by at least one bit in the MAC-CE (e.g., as described in connection with FIG. 5B) to the CORESET in serving cells on the list for which the CORESET is configured for non-SFN transmissions.

As an alternative, the UE 120 may apply a default TCI state (e.g., indicated in an RRC message) to the CORESET in serving cells on the list for which the CORESET is configured for non-SFN transmissions. As an alternative, the UE 120 may use an already-activated TCI state for the CORESET in serving cells on the list for which the CORESET is configured for non-SFN transmissions. Accordingly, the UE 120 refrains from changing a TCI state for the CORESET in serving cells on the list for which the CORESET is configured for non-SFN transmissions. As a result, the UE 120 is able to process the MAC-CE and apply the two TCI states in at least some serving cells to communicate with the network.

As an alternative, the network may use the MAC-CE to implicitly change the configuration of the CORESET. Accordingly, the UE 120 may reconfigure the CORESET for SFN transmissions in serving cells on the list for which the CORESET was configured for non-SFN transmissions. As a result, the network is able to reconfigure the CORESET for SFN transmissions with less signaling overhead compared to RRC, and the UE 120 is able to process the MAC-CE and apply the two TCI states in all serving cells on the list.

By using techniques as described in connection with FIG. 4, the UE 120 is able to process a control element that indicates two TCI states when one or more additional serving cells, included in a same list of serving cells as a first serving cell, are not configured for SFN. As a result, the UE 120 and the corresponding network (e.g., including base station 110a and/or base station 110b) experience increased reliability and quality of communications. Increased reliability and quality reduces chances of retransmissions, which therefore conserves power and processing resources at the UE 120 and at the network.

As indicated above, FIG. 4 is provided as an example. Other examples may differ from what is described with respect to FIG. 4.

FIGS. 5A and 5B are diagrams illustrating examples 500 and 550 associated with control elements indicating multiple TCI states, in accordance with the present disclosure. As shown in FIGS. 5A and 5B, a control element, such as a MAC-CE, may include an indication of a serving cell (e.g., a serving cell ID) and an indication of a CORESET (e.g., a CORESET ID). For example, the serving cell ID and/or the CORESET ID may be encoded in one or more bits of a first octet (shown as “Oct 1”) of the MAC-CE. Additionally, or alternatively, the CORESET ID may be encoded in one or more bits of a second octet (shown as “Oct 2”) of the MAC-CE.

As further shown in FIGS. 5A and 5B, the control element may indicate two TCI states. For example, one or more bits of the second octet may indicate a first TCI state, and one or more bits of a third octet (shown as “Oct 3”) may indicate a second TCI state (also referred to as a “last” TCI state).

In some aspects, as shown in FIG. 5A, the third octet may additionally include a reserve bit (shown as “R”). As an alternative, the third octet may include a TCI state flag (shown as “C”) that indicates which, of the first and second TCI states, to apply to the CORESET (indicated by CORESET ID) when the CORESET is configured for non-SFN transmissions in a serving cell.

As indicated above, FIGS. 5A and 5B are provided as examples. Other examples may differ from what is described with respect to FIGS. 5A and 5B. For example, the serving cell ID, the CORESET ID, an indication of the first TCI state, an indication of the second TCI state, and/or additional bits (e.g., the control bit or the TCI state flag) may be included in different octets than described in connection with FIG. 5A or FIG. 5B.

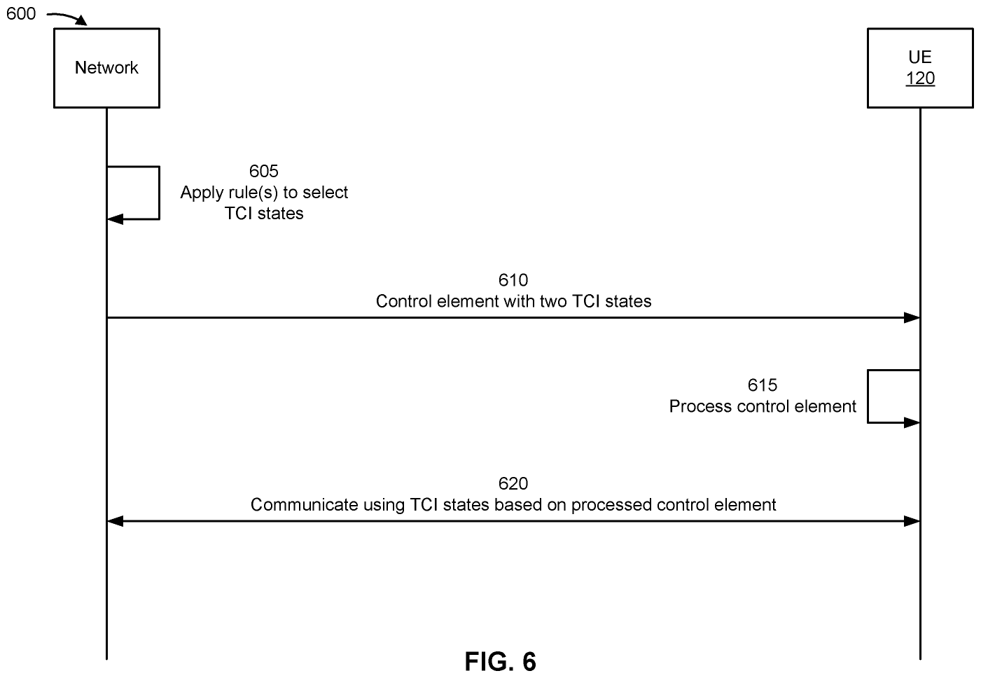

FIG. 6 is a diagram illustrating an example 600 associated with processing multiple TCI states for serving cells not configured for SFN transmissions, in accordance with the present disclosure. As shown in FIG. 6, a network (e.g., including base station 110a and/or base station 110b) and a UE 120 may communicate with one another. As described in connection with FIG. 4, the network may use CA with the UE 120 to increase throughput and may configure a list of serving cells (corresponding to CCs) for which the network may simultaneously configure TCI states.

As shown by reference number 605, the network may apply one or more rules to select TCI states to update for the UE 120. For example, the network may apply rule(s) as described in connection with FIG. 4 to ensure that a MAC-CE with two TCI states (e.g., as described in connection with FIG. 5A or FIG. 5B) may be applied to a CORESET across serving cells in a list of serving cells.

As shown by reference number 610, the network may transmit, and the UE 120 may receive, a control element, such as a MAC-CE, indicating two TCI states. Accordingly, as shown by reference number 615, the UE 120 may process the MAC-CE. For example, the rule(s) applied by the network may ensure that the UE 120 can apply the two TCI states to the CORESET indicated in the control element across all serving cells on the list. As an alternative, the UE 120 may process the MAC-CE as described in connection with FIG. 4. For example, the network may be permitted to transmit a MAC-CE with two TCI states even when the indicated CORESET is configured for non-SFN transmissions in one or more serving cells on the list.

As shown by reference number 620, after processing the MAC-CE, the network and the UE 120 may communicate. For example, the network and the UE 120 may apply the same processing techniques to the MAC-CE such that the network and the UE 120 use the same TCI states to transmit and receive from each other.

By using techniques as described in connection with FIG. 6, the UE 120 is able to process a control element that indicates two TCI states when one or more additional serving cells, included in a same list of serving cells as a first serving cell, are not configured for SFN. As a result, the UE 120 and the corresponding network experience increased reliability and quality of communications. Increased reliability and quality reduces chances of retransmissions, which therefore conserves power and processing resources at the UE 120 and at the network.

As indicated above, FIG. 6 is provided as an example. Other examples may differ from what is described with respect to FIG. 6.

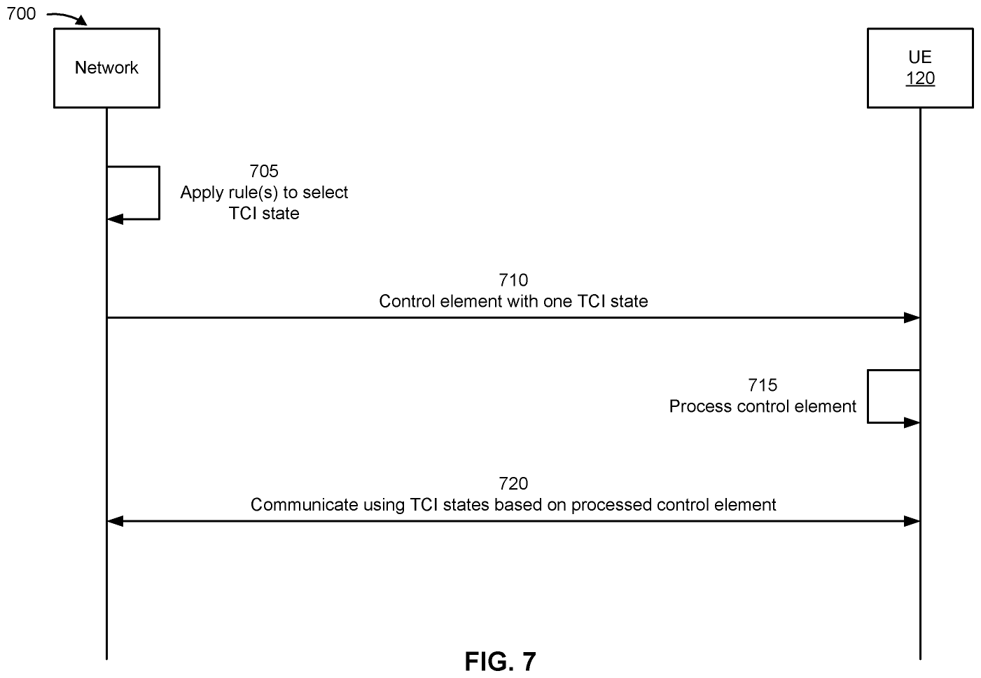

FIG. 7 is a diagram illustrating an example 700 associated with processing a single TCI state for serving cells configured for SFN transmissions, in accordance with the present disclosure. As shown in FIG. 7, a network (e.g., including base station 110a and/or base station 110b) and a UE 120 may communicate with one another. As described in connection with FIG. 4, the network may use CA with the UE 120 to increase throughput and may configure a list of serving cells (corresponding to CCs) for which the network may simultaneously configure TCI states.

As shown by reference number 705, the network may apply one or more rules to select a TCI state to update for the UE 120. For example, the network may apply rule(s) as described in connection with FIG. 4 to ensure that a MAC-CE with a single TCI state may be applied to a CORESET across serving cells in a list of serving cells.

As shown by reference number 710, the network may transmit, and the UE 120 may receive, a control element, such as a MAC-CE, indicating one TCI state. Accordingly, as shown by reference number 715, the UE 120 may process the MAC-CE. For example, the rule(s) applied by the network may ensure that the UE 120 can apply the TCI state to the CORESET indicated in the control element across all serving cells on the list.

However, in some situations, the list may still include a serving cell in which the CORESET is configured for SFN (and thus uses two TCI states). For example, the network may transmit the MAC-CE before updating the list of serving cells in an error case. Accordingly, the UE 120 may discard the MAC-CE and not update TCI states associated with any serving cell. As a result, the network and the UE 120 both discard the MAC-CE and use already-activated TCI states for the CORESET across serving cells to communicate.

In another example, the network may be allowed to transmit the MAC-CE with a single TCI state even when the list still includes at least one serving cell in which the CORESET is configured for SFN. Accordingly, the UE 120 may change one of the first TCI state associated with the CORESET or the second TCI state associated with the CORESET to the TCI state indicated in the MAC-CE in serving cells on the list for which the CORESET is configured for SFN transmissions. Additionally, the UE 120 may apply a default TCI state (e.g., indicated in an RRC message) as the other of the first TCI state associated with the CORESET or the second TCI state associated with the CORESET in serving cells on the list for which the CORESET is configured for SFN transmissions. As an alternative, the UE 120 may use an already-activated TCI state as the other of the first TCI state associated with the CORESET or the second TCI state associated with the CORESET in serving cells on the list for which the CORESET is configured for SFN transmissions. As a result, the UE 120 is able to process the MAC-CE and apply the one TCI state in at least some serving cells to communicate with the network.

As an alternative, the network may use the MAC-CE to implicitly change the configuration of the CORESET. Accordingly, the UE 120 may reconfigure the CORESET for non-SFN transmissions in serving cells on the list for which the CORESET was configured for SFN transmissions. As a result, the network is able to reconfigure the CORESET for non-SFN transmissions with less signaling overhead compared to RRC, and the UE 120 is able to process the MAC-CE and apply the TCI state in all serving cells on the list.

As shown by reference number 720, after processing the MAC-CE, the network and the UE 120 may communicate. For example, the network and the UE 120 may apply the same processing techniques to the MAC-CE such that the network and the UE 120 use the same TCI states to transmit and receive from each other.

By using techniques as described in connection with FIG. 7, the UE 120 is able to process a control element that indicates one TCI state when one or more additional serving cells, included in a same list of serving cells as a first serving cell, are configured for SFN. As a result, the UE 120 and the corresponding network experience increased reliability and quality of communications. Increased reliability and quality reduces chances of retransmissions, which therefore conserves power and processing resources at the UE 120 and at the network.

As indicated above, FIG. 7 is provided as an example. Other examples may differ from what is described with respect to FIG. 7.

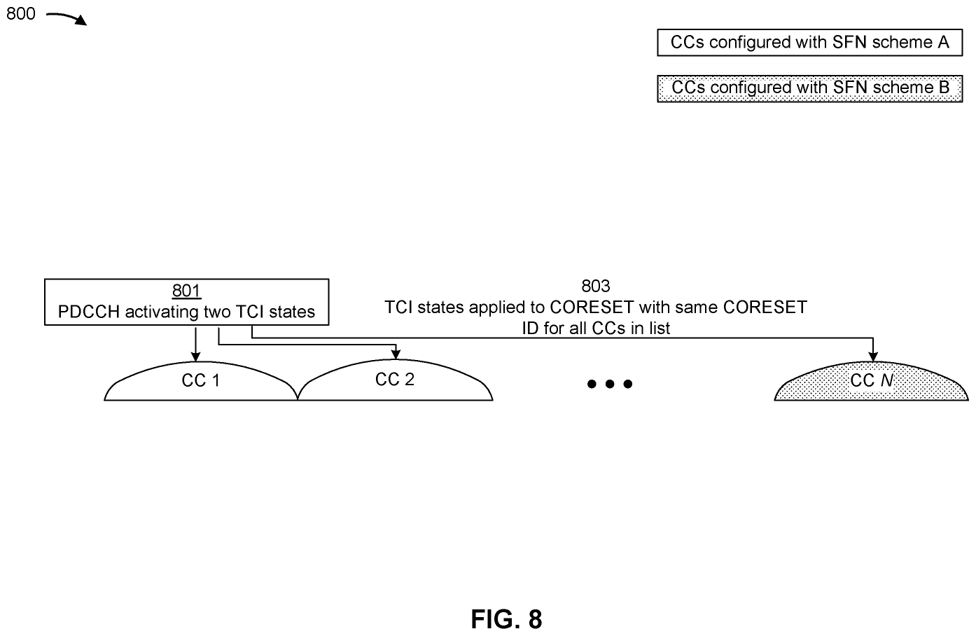

FIG. 8 is a diagram illustrating an example 800 associated with a list of serving cells for simultaneous TCI state configuration, in accordance with the present disclosure. As shown in FIG. 8, example 800 includes a plurality of CCs, each used by a different serving cell to transmit to a UE (e.g., UE 120). Accordingly, the CCs may be used together to increase throughput to the UE 120 via CA. Each CC may be associated with a corresponding CORESET.

The network may configure (e.g., via RRC signaling) a list of the serving cells (e.g., a list including serving cell IDs) such that the network may simultaneously update TCI states for a CORESET across the CCs associated with the serving cells on the list. In some aspects, the list may include a simultaneousTCI-UpdateList1 and/or a simultaneousTCI-Update List2 data structure, as defined in 3GPP specifications and/or another standard. Additionally, or alternatively, the list may include a new data structure defined in 3GPP specifications and/or another standard.

Accordingly, as shown by reference number 801, the network may transmit a control element, such as a MAC-CE, to the UE 120 (e.g., on a PDCCH) that activates two TCI states. For example, the MAC-CE may be structured as described in connection with FIG. 5A or FIG. 5B. The MAC-CE may indicate a CORESET (e.g., using a CORESET ID) such that, as shown by reference number 803, the UE 120 may apply the two TCI states to the CORESET in the serving cells indicated in the list. The list may include at least a first serving cell in which the CORESET is configured for one type of SFN and optionally with one or more additional serving cells in which the CORESET is configured for a different type of SFN. For example, as shown in FIG. 8, a first serving cell (corresponding to a first CC) and a second serving cell (corresponding to a second CC) on the list are configured for SFN scheme A (e.g., as described in connection with FIG. 3A) and a last serving cell (corresponding to a last CC) is configured for SFN scheme B (e.g., as described in connection with FIG. 3B).

The network may apply one or more rules to generate the MAC-CE. For example, the rule(s) may indicate that the list only include serving cells in which the CORESET is configured for SFN scheme A or only include serving cells in which the CORESET is configured for SFN scheme B.

Accordingly, to comply with any of the rules described above, the network may update the list of serving cells based at least in part on CORESETs within the serving cells being configured for SFN scheme A or SFN scheme B. For example, the network may use RRC signaling and/or a control element, such as a MAC-CE, to remove a serving cell from the list when the serving cell does not comply with the rule(s). Similarly, the network may also add a serving cell to the list when the serving cell does comply with the rule(s).

The rule(s) can help ensure that the UE 120 can apply the two TCI states indicated in a MAC-CE to the CORESET across all serving cells in the list. However, in some situations, the list may still include an additional serving cell in which the CORESET is configured for a different type of SFN transmissions than a first serving cell in the list. For example, the network may transmit the MAC-CE before updating the list of serving cells in an error case. Accordingly, the UE 120 may discard the MAC-CE and not update TCI states associated with any serving cell. As a result, the network and the UE 120 both discard the MAC-CE and use already-activated TCI states for the CORESET across serving cells to communicate.

In another example, the network may be allowed to transmit the MAC-CE even when the list still includes at least one additional serving cell in which the CORESET is configured for a different type of SFN transmissions than a first serving cell in the list. Accordingly, the UE 120 may apply the TCI states indicated in the MAC-CE (e.g., as described in connection with FIG. 5A) to the CORESET in serving cells on the list associated with one type of SFN transmissions (e.g., only to serving cells in which the CORESET is configured for SFN scheme A or SFN scheme B). The UE 120 may select which type of SFN transmissions based at least in part on a type of SFN transmissions associated with the CORESET and the serving cell in which the MAC-CE was received, a type of SFN transmissions associated with the CORESET for the serving cell associated with a lowest ID, a type of SFN transmissions associated with the CORESET for the serving cell associated with a highest ID, or a majority rule (e.g., whether more serving cells on the list are associated with SFN scheme A or SFN scheme B). As an alternative, the UE 120 may select the type of SFN transmissions indicated by at least one bit in the MAC-CE (e.g., as described in connection with FIG. 5B). For example, the flag “C” described in connection with FIG. 5B may indicate whether to apply the TCI states indicated in the MAC-CE to serving cells in which the CORESET is configured for SFN scheme A or to serving cells in which the CORESET is configured for SFN scheme B.

As an alternative, the network may use the MAC-CE to implicitly change the configuration of the CORESET. Accordingly, the UE 120 may reconfigure the CORESET for SFN scheme A in serving cells on the list for which the CORESET was configured for SFN scheme B or may reconfigure the CORESET for SFN scheme B in serving cells on the list for which the CORESET was configured for SFN scheme A. The UE 120 may select serving cells in which to reconfigure the CORESET based at least in part on a type of SFN transmissions associated with the CORESET and the serving cell in which the MAC-CE was received, a type of SFN transmissions associated with the CORESET for the serving cell associated with a lowest ID, a type of SFN transmissions associated with the CORESET for the serving cell associated with a highest ID, or a majority rule (e.g., whether more serving cells on the list are associated with SFN scheme A or SFN scheme B). As a result, the network is able to reconfigure the CORESET for a different type of SFN transmissions with less signaling overhead compared to RRC, and the UE 120 is able to process the MAC-CE and apply the two TCI states in all serving cells on the list.

By using techniques as described in connection with FIG. 8, the UE 120 is able to process a control element that indicates two TCI states when one or more additional serving cells, included in a same list of serving cells as a first serving cell, are configured for a different type of SFN than the first serving cell. As a result, the UE 120 and the corresponding network (e.g., including base station 110a and/or base station 110b) experience increased reliability and quality of communications. Increased reliability and quality reduces chances of retransmissions, which therefore conserves power and processing resources at the UE 120 and at the network.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120 and/or apparatus 1300 of FIG. 13) performs operations associated with processing multiple TCI states for serving cells not configured for SFN transmissions.

As shown in FIG. 9, in some aspects, process 900 may include receiving, from a network (e.g., including base station 110 and/or apparatus 1400 of FIG. 14), a list of serving cells including a first serving cell that is using a CORESET for SFN transmissions (block 910). For example, the UE (e.g., using communication manager 140 and/or reception component 1302, depicted in FIG. 13) may receive, from a network, a list of serving cells including a first serving cell that is using a CORESET for SFN transmissions, as described herein.

As further shown in FIG. 9, in some aspects, process 900 may include receiving, from the network, a control element indicating two TCI states and associated with the first serving cell and the CORESET (block 920). For example, the UE (e.g., using communication manager 140 and/or reception component 1302) may receive, from the network, a control element indicating two TCI states and associated with the first serving cell and the CORESET, as described herein.

As further shown in FIG. 9, in some aspects, process 900 may include processing the control element based at least in part on determining that one or more additional serving cells in the list are not using the CORESET for SFN transmissions (block 930). For example, the UE (e.g., using communication manager 140 and/or control element component 1308, depicted in FIG. 13) may process the control element based at least in part on determining that one or more additional serving cells in the list are not using the CORESET for SFN transmissions, as described herein.

Process 900 may include additional aspects, such as any single aspect or any combination of aspects described below and/or in connection with one or more other processes described elsewhere herein.

In a first aspect, processing the control element includes applying the two TCI states for the CORESET in the first serving cell, and applying one TCI state, of the two TCI states, for the CORESET in the one or more additional serving cells.

In a second aspect, alone or in combination with the first aspect, the one TCI state, of the two TCI states, is indicated by a bit included in the control element.

In a third aspect, alone or in combination with one or more of the first and second aspects, processing the control element includes applying the two TCI states for the CORESET in the first serving cell, and applying a default TCI state for the CORESET in the one or more additional serving cells.

In a fourth aspect, alone or in combination with one or more of the first through third aspects, processing the control element includes applying the two TCI states for the CORESET in the first serving cell, and refraining from changing a TCI state for the CORESET in the one or more additional serving cells.

In a fifth aspect, alone or in combination with one or more of the first through fourth aspects, processing the control element includes discarding the control element, and refraining from changing a TCI state for the CORESET in the first serving cell and the one or more additional serving cells.

In a sixth aspect, alone or in combination with one or more of the first through fifth aspects, processing the control element includes applying the two TCI states for the CORESET in the first serving cell, reconfiguring the CORESET in the one or more additional serving cells for SFN transmissions, and applying the two TCI states for the CORESET in the one or more additional serving cells.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110 and/or apparatus 1400 of FIG. 14) performs operations associated with processing multiple TCI states for serving cells not configured for SFN transmissions.

As shown in FIG. 10, in some aspects, process 1000 may include transmitting, to a UE (e.g., UE 120 and/or apparatus 1300 of FIG. 13), a list of serving cells including a first serving cell that is using a CORESET for SFN transmissions (block 1010). For example, the base station (e.g., using communication manager 150 and/or transmission component 1404, depicted in FIG. 14) may transmit, to a UE, a list of serving cells including a first serving cell that is using a CORESET for SFN transmissions, as described herein.

As further shown in FIG. 10, in some aspects, process 1000 may include transmitting, to the UE, a control element indicating two TCI states and associated with the first serving cell and the CORESET (block 1020). For example, the base station (e.g., using communication manager 150 and/or transmission component 1404) may transmit, to the UE, a control element indicating two TCI states and associated with the first serving cell and the CORESET, as described herein. In some aspects, the control element is based at least in part on one or more rules associated with the list of serving cells.

Process 1000 may include additional aspects, such as any single aspect or any combination of aspects described below and/or in connection with one or more other processes described elsewhere herein.

In a first aspect, the one or more rules include a requirement that the CORESET be configured for SFN transmissions in each serving cell on the list of serving cells.

In a second aspect, alone or in combination with the first aspect, the one or more rules include a requirement that the CORESET be configured for a same type of SFN transmissions in each serving cell on the list of serving cells.

In a third aspect, alone or in combination with one or more of the first and second aspects, the one or more rules include a requirement that all CORESETs be configured for SFN transmissions in each serving cell on the list of serving cells.

In a fourth aspect, alone or in combination with one or more of the first through third aspects, the one or more rules include a requirement that at least one CORESET be configured for SFN transmissions in each serving cell on the list of serving cells.

In a fifth aspect, alone or in combination with one or more of the first through fourth aspects, process 1000 further includes transmitting (e.g., using communication manager 150 and/or transmission component 1404), to the UE, an indication to remove at least one serving cell from the list of serving cells to comply with the one or more rules.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120 and/or apparatus 1300 of FIG. 13) performs operations associated with processing a single TCI state for serving cells configured for SFN transmissions.

As shown in FIG. 11, in some aspects, process 1100 may include receiving, from a network (e.g., including base station 110 and/or apparatus 1400 of FIG. 14), a control element indicating one TCI state and associated with a first serving cell and a CORESET (block 1110). For example, the UE (e.g., using communication manager 140 and/or reception component 1302, depicted in FIG. 13) may receive, from a network, a control element indicating one TCI state and associated with a first serving cell and a CORESET, as described herein.

As further shown in FIG. 11, in some aspects, process 1100 may include processing the control element based at least in part on determining that the CORESET is used for SFN transmissions in the first serving cell and is associated with two TCI states (block 1120). For example, the UE (e.g., using communication manager 140 and/or control element component 1308, depicted in FIG. 13) may process the control element based at least in part on determining that the CORESET is used for SFN transmissions in the first serving cell and is associated with two TCI states, as described herein.

Process 1100 may include additional aspects, such as any single aspect or any combination of aspects described below and/or in connection with one or more other processes described elsewhere herein.

In a first aspect, processing the control element includes discarding the control element, and refraining from changing the two TCI states for the CORESET in the first serving cell.

In a second aspect, alone or in combination with the first aspect, processing the control element includes changing one TCI state, of the two TCI states, for the CORESET in the first serving cell, to the TCI state indicated by the control element.

In a third aspect, alone or in combination with one or more of the first and second aspects, processing the control element includes changing the other TCI state, of the two TCI states, for the CORESET in the first serving cell, to a default TCI state.

In a fourth aspect, alone or in combination with one or more of the first through third aspects, processing the control element includes changing a TCI state, for the CORESET in one or more additional serving cells included in a list of serving cells with the first serving cell, to the TCI state indicated by the control element.

In a fifth aspect, alone or in combination with one or more of the first through fourth aspects, processing the control element includes reconfiguring the CORESET in the first serving cell for non-SFN transmissions, and applying the TCI state indicated in the control element for the CORESET in the first serving cell.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120 and/or apparatus 1300 of FIG. 13) performs operations associated with processing TCI states for serving cells configured for different types of SFN transmissions.

As shown in FIG. 12, in some aspects, process 1200 may include receiving, from a network (e.g., including base station 110 and/or apparatus 1400 of FIG. 14), a list of serving cells including a first serving cell that is using a CORESET for a first type of SFN transmissions (block 1210). For example, the UE (e.g., using communication manager 140 and/or reception component 1302, depicted in FIG. 13) may receive, from a network, a list of serving cells including a first serving cell that is using a CORESET for a first type of SFN transmissions, as described herein.

As further shown in FIG. 12, in some aspects, process 1200 may include receiving, from the network, a control element indicating two TCI states and associated with the first serving cell and the CORESET (block 1220). For example, the UE (e.g., using communication manager 140 and/or reception component 1302) may receive, from the network, a control element indicating two TCI states and associated with the first serving cell and the CORESET, as described herein.

As further shown in FIG. 12, in some aspects, process 1200 may include processing the control element based at least in part on determining that one or more additional serving cells in the list are not using the CORESET for the first type of SFN transmissions (block 1230). For example, the UE (e.g., using communication manager 140 and/or control element component 1308, depicted in FIG. 13) may process the control element based at least in part on determining that one or more additional serving cells in the list are not using the CORESET for the first type of SFN transmissions, as described herein.

Process 1200 may include additional aspects, such as any single aspect or any combination of aspects described below and/or in connection with one or more other processes described elsewhere herein.

In a first aspect, processing the control element includes discarding the control element, and refraining from changing the two TCI states for the CORESET in the first serving cell.

In a second aspect, alone or in combination with the first aspect, processing the control element includes applying the two TCI states for the CORESET in the first serving cell, and refraining from changing TCI states for the CORESET in the one or more additional serving cells.

In a third aspect, alone or in combination with one or more of the first and second aspects, the first serving cell is associated with a lowest or highest index for a CC associated with the CORESET.

In a fourth aspect, alone or in combination with one or more of the first through third aspects, the first serving cell is associated with a CC used to receive the control element.

In a fifth aspect, alone or in combination with one or more of the first through fourth aspects, the first type of SFN transmissions is associated with a majority of cells included in the list of serving cells.

In a sixth aspect, alone or in combination with one or more of the first through fifth aspects, first type of SFN transmissions is indicated by a bit included in the control element.

In a seventh aspect, alone or in combination with one or more of the first through sixth aspects, processing the control element includes applying the two TCI states for the CORESET in the first serving cell, reconfiguring the CORESET in the one or more additional serving cells for the first type of SFN transmissions, and applying the two TCI states for the CORESET in the one or more additional serving cells.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a control element component 1308, a TCI state component 1310, or an SFN configuration component 1312, among other examples.

In some aspects, the apparatus 1300 may be configured to perform one or more operations described herein in connection with FIGS. 4-8. Additionally, or alternatively, the apparatus 1300 may be configured to perform one or more processes described herein, such as process 900 of FIG. 9, process 1100 of FIG. 11, process 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

In some aspects, the reception component 1302 may receive (e.g., from a network including apparatus 1306) a list of serving cells including a first serving cell that is using a CORESET for SFN transmissions. Additionally, the reception component 1302 may receive (e.g., from the apparatus 1306) a control element indicating two TCI states and associated with the first serving cell and the CORESET. Accordingly, the control element component 1308 may process the control element based at least in part on determining that one or more additional serving cells in the list are not using the CORESET for SFN transmissions. For example, the control element component 1308 may discard the control element. The control element component 1308 may include a modem, a demodulator, a MIMO detector, a receive processor, a controller/processor, a memory, or a combination thereof, of the UE described in connection with FIG. 2. In another example, the TCI state component 1310 may apply the two TCI states to the CORESET in the first serving cell. The TCI state component 1310 may additionally refrain from changing a TCI state associated with the CORESET in the one or more additional serving cells or may change the TCI state based at least in part on the control element. The TCI state component 1310 may include a modem, a demodulator, a MIMO detector, a receive processor, a controller/processor, a memory, or a combination thereof, of the UE described in connection with FIG. 2. In another example, the SFN configuration component 1312 may reconfigure the CORESET for SFN transmissions in the one or more additional serving cells based at least in part on the control element. The SFN configuration component 1312 may include a modem, a demodulator, a MIMO detector, a receive processor, a controller/processor, a memory, or a combination thereof, of the UE described in connection with FIG. 2.

As an alternative, the reception component 1302 may receive (e.g., from a network including apparatus 1306) a control element indicating one TCI state and associated with a first serving cell and a CORESET. Accordingly, the control element component 1308 may process the control element based at least in part on determining that the CORESET is used for SFN transmissions in the first serving cell and is associated with two TCI states. For example, the control element component 1308 may discard the control element. In another example, the TCI state component 1310 may apply the single TCI state to the CORESET in the first serving cell. In another example, the SFN configuration component 1312 may reconfigure the CORESET for non-SFN transmissions in the first serving cell based at least in part on the control element.

As an alternative, the reception component 1302 may receive (e.g., from a network including apparatus 1306) a list of serving cells including a first serving cell that is using a CORESET for a first type of SFN transmissions. Additionally, the reception component 1302 may receive (e.g., from the apparatus 1306) a control element indicating two TCI states and associated with the first serving cell and the CORESET. Accordingly, the control element component 1308 may process the control element based at least in part on determining that one or more additional serving cells in the list are not using the CORESET for the first type of SFN transmissions. For example, the control element component 1308 may discard the control element. In another example, the TCI state component 1310 may apply the single TCI state to the CORESET in the first serving cell or in the one or more additional serving cells. In another example, the SFN configuration component 1312 may reconfigure the CORESET for the same type of SFN transmissions across the list of serving cells based at least in part on the control element.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a base station, or a base station may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a rules component 1408, among other examples.

In some aspects, the apparatus 1400 may be configured to perform one or more operations described herein in connection with FIGS. 4-8. Additionally, or alternatively, the apparatus 1400 may be configured to perform one or more processes described herein, such as process 1000 of FIG. 10, or a combination thereof. In some aspects, the apparatus 1400 and/or one or more components shown in FIG. 14 may include one or more components of the base station described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the base station described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the base station described in connection with FIG. 2. In some aspects, the transmission component 1404 may be co-located with the reception component 1402 in a transceiver.

In some aspects, the transmission component 1404 may transmit (e.g., to a UE, such as apparatus 1406) a list of serving cells including a first serving cell that is using a CORESET for SFN transmissions. Additionally, the transmission component 1404 may transmit (e.g., to the apparatus 1406) a control element indicating two TCI states and associated with the first serving cell and the CORESET. The rules component 1408 may generate the control element based at least in part on one or more rules associated with the list of serving cells. For example, the transmission component 1404 may transmit (e.g., to the apparatus 1406) an indication to remove at least one serving cell from the list of serving cells to comply with the one or more rules before the transmission component 1404 transmits the control element. Similarly, the transmission component 1404 may transmit a control element indicating one TCI state and based at least in part on one or more rules associated with the list of serving cells.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a network, a list of serving cells including a first serving cell that is using a control resource set (CORESET) for single frequency network (SFN) transmissions; receiving, from the network, a control element indicating two transmission configuration indicator (TCI) states and associated with the first serving cell and the CORESET; and processing the control element based at least in part on determining that one or more additional serving cells in the list are not using the CORESET for SFN transmissions.

Aspect 2: The method of Aspect 1, wherein processing the control element comprises: applying the two TCI states for the CORESET in the first serving cell; and applying one TCI state, of the two TCI states, for the CORESET in the one or more additional serving cells.

Aspect 3: The method of Aspect 2, wherein the one TCI state, of the two TCI states, is indicated by a bit included in the control element.

Aspect 4: The method of Aspect 1, wherein processing the control element comprises: applying the two TCI states for the CORESET in the first serving cell; and applying a default TCI state for the CORESET in the one or more additional serving cells.

Aspect 5: The method of Aspect 1, wherein processing the control element comprises: applying the two TCI states for the CORESET in the first serving cell; and refraining from changing a TCI state for the CORESET in the one or more additional serving cells.

Aspect 6: The method of Aspect 1, wherein processing the control element comprises: discarding the control element; and refraining from changing a TCI state for the CORESET in the first serving cell and the one or more additional serving cells.

Aspect 7: The method of Aspect 1, wherein processing the control element comprises: applying the two TCI states for the CORESET in the first serving cell; reconfiguring the CORESET in the one or more additional serving cells for SFN transmissions; and applying the two TCI states for the CORESET in the one or more additional serving cells.

Aspect 8: A method of wireless communication performed by a base station, comprising: transmitting, to a user equipment (UE), a list of serving cells including a first serving cell that is using a control resource set (CORESET) for single frequency network (SFN) transmissions; and transmitting, to the UE, a control element indicating two transmission configuration indicator (TCI) states and associated with the first serving cell and the CORESET, wherein the control element is based at least in part on one or more rules associated with the list of serving cells.

Aspect 9: The method of Aspect 8, wherein the one or more rules include a requirement that the CORESET be configured for SFN transmissions in each serving cell on the list of serving cells.

Aspect 10: The method of Aspect 8, wherein the one or more rules include a requirement that the CORESET be configured for a same type of SFN transmissions in each serving cell on the list of serving cells.

Aspect 11: The method of Aspect 8, wherein the one or more rules include a requirement that all CORESETs be configured for SFN transmissions in each serving cell on the list of serving cells.

Aspect 12: The method of Aspect 8, wherein the one or more rules include a requirement that at least one CORESET be configured for SFN transmissions in each serving cell on the list of serving cells.

Aspect 13: The method of any of Aspects 8 through 12, further comprising: transmitting, to the UE, an indication to remove at least one serving cell from the list of serving cells to comply with the one or more rules.

Aspect 14: A method of wireless communication performed by a user equipment (UE), comprising: receiving, from a network, a control element indicating one transmission configuration indicator (TCI) state and associated with a first serving cell and a control resource set (CORESET); and processing the control element based at least in part on determining that the CORESET is used for single frequency network (SFN) transmissions in the first serving cell and is associated with two TCI states.

Aspect 15: The method of Aspect 14, wherein processing the control element comprises: discarding the control element; and refraining from changing the two TCI states for the CORESET in the first serving cell.

Aspect 16: The method of Aspect 14, wherein processing the control element comprises: changing one TCI state, of the two TCI states, for the CORESET in the first serving cell, to the TCI state indicated by the control element.

Aspect 17: The method of Aspect 14, wherein processing the control element comprises: changing the other TCI state, of the two TCI states, for the CORESET in the first serving cell, to a default TCI state.

Aspect 18: The method of Aspect 14, wherein processing the control element comprises: changing a TCI state, for the CORESET in one or more additional serving cells included in a list of serving cells with the first serving cell, to the TCI state indicated by the control element.

Aspect 19: The method of Aspect 14, wherein processing the control element comprises: reconfiguring the CORESET in the first serving cell for non-SFN transmissions; and applying the TCI state indicated in the control element for the CORESET in the first serving cell.

Aspect 20: A method of wireless communication performed by a user equipment (UE), comprising: receiving, from a network, a list of serving cells including a first serving cell that is using a control resource set (CORESET) for a first type of single frequency network (SFN) transmissions; receiving, from the network, a control element indicating two transmission configuration indicator (TCI) states and associated with the first serving cell and the CORESET; and processing the control element based at least in part on determining that one or more additional serving cells in the list are not using the CORESET for the first type of SFN transmissions.

Aspect 21: The method of Aspect 20, wherein processing the control element comprises: discarding the control element; and refraining from changing the two TCI states for the CORESET in the first serving cell.

Aspect 22: The method of Aspect 20, wherein processing the control element comprises: applying the two TCI states for the CORESET in the first serving cell; and refraining from changing TCI states for the CORESET in the one or more additional serving cells.

Aspect 23: The method of Aspect 22, wherein the first serving cell is associated with a lowest or highest index for a component carrier (CC) associated with the CORESET.

Aspect 24: The method of Aspect 22, wherein the first serving cell is associated with a component carrier (CC) used to receive the control element.

Aspect 25: The method of Aspect 22, wherein the first type of SFN transmissions is associated with a majority of cells included in the list of serving cells.

Aspect 26: The method of Aspect 22, wherein first type of SFN transmissions is indicated by a bit included in the control element.

Aspect 27: The method of Aspect 20, wherein processing the control element comprises: applying the two TCI states for the CORESET in the first serving cell; reconfiguring the CORESET in the one or more additional serving cells for the first type of SFN transmissions; and applying the two TCI states for the CORESET in the one or more additional serving cells.

Aspect 28: An apparatus for wireless communication at a device, comprising a processor; memory coupled with the processor; and instructions stored in the memory and executable by the processor to cause the apparatus to perform the method of one or more of Aspects 1-7.

Aspect 29: A device for wireless communication, comprising a memory and one or more processors coupled to the memory, the one or more processors configured to perform the method of one or more of Aspects 1-7.

Aspect 30: An apparatus for wireless communication, comprising at least one means for performing the method of one or more of Aspects 1-7.

Aspect 31: A non-transitory computer-readable medium storing code for wireless communication, the code comprising instructions executable by a processor to perform the method of one or more of Aspects 1-7.

Aspect 32: A non-transitory computer-readable medium storing a set of instructions for wireless communication, the set of instructions comprising one or more instructions that, when executed by one or more processors of a device, cause the device to perform the method of one or more of Aspects 1-7.

Aspect 33: An apparatus for wireless communication at a device, comprising a processor; memory coupled with the processor; and instructions stored in the memory and executable by the processor to cause the apparatus to perform the method of one or more of Aspects 8-13.

Aspect 34: A device for wireless communication, comprising a memory and one or more processors coupled to the memory, the one or more processors configured to perform the method of one or more of Aspects 8-13.

Aspect 35: An apparatus for wireless communication, comprising at least one means for performing the method of one or more of Aspects 8-13.

Aspect 36: A non-transitory computer-readable medium storing code for wireless communication, the code comprising instructions executable by a processor to perform the method of one or more of Aspects 8-13.

Aspect 37: A non-transitory computer-readable medium storing a set of instructions for wireless communication, the set of instructions comprising one or more instructions that, when executed by one or more processors of a device, cause the device to perform the method of one or more of Aspects 8-13.

Aspect 38: An apparatus for wireless communication at a device, comprising a processor; memory coupled with the processor; and instructions stored in the memory and executable by the processor to cause the apparatus to perform the method of one or more of Aspects 14-19.

Aspect 39: A device for wireless communication, comprising a memory and one or more processors coupled to the memory, the one or more processors configured to perform the method of one or more of Aspects 14-19.

Aspect 40: An apparatus for wireless communication, comprising at least one means for performing the method of one or more of Aspects 14-19.

Aspect 41: A non-transitory computer-readable medium storing code for wireless communication, the code comprising instructions executable by a processor to perform the method of one or more of Aspects 14-19.

Aspect 42: A non-transitory computer-readable medium storing a set of instructions for wireless communication, the set of instructions comprising one or more instructions that, when executed by one or more processors of a device, cause the device to perform the method of one or more of Aspects 14-19.

Aspect 43: An apparatus for wireless communication at a device, comprising a processor; memory coupled with the processor; and instructions stored in the memory and executable by the processor to cause the apparatus to perform the method of one or more of Aspects 20-27.

Aspect 44: A device for wireless communication, comprising a memory and one or more processors coupled to the memory, the one or more processors configured to perform the method of one or more of Aspects 20-27.

Aspect 45: An apparatus for wireless communication, comprising at least one means for performing the method of one or more of Aspects 20-27.

Aspect 46: A non-transitory computer-readable medium storing code for wireless communication, the code comprising instructions executable by a processor to perform the method of one or more of Aspects 20-27.

Aspect 47: A non-transitory computer-readable medium storing a set of instructions for wireless communication, the set of instructions comprising one or more instructions that, when executed by one or more processors of a device, cause the device to perform the method of one or more of Aspects 20-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network, a list of serving cells including a first serving cell that is using a control resource set (CORESET) for single frequency network (SFN) transmissions;
receive, from the network, a control element indicating two transmission configuration indicator (TCI) states and associated with the first serving cell and the CORESET; and
process the control element based at least in part on determining that one or more additional serving cells in the list are not using the CORESET for SFN transmissions.

2. The apparatus of claim 1, wherein, to process the control element, the one or more processors are configured to:
apply the two TCI states for the CORESET in the first serving cell; and
apply one TCI state, of the two TCI states, for the CORESET in the one or more additional serving cells.

3. The apparatus of claim 2, wherein the one TCI state, of the two TCI states, is indicated by a bit included in the control element.

4. The apparatus of claim 1, wherein, to process the control element, the one or more processors are configured to:
apply the two TCI states for the CORESET in the first serving cell; and
apply a default TCI state for the CORESET in the one or more additional serving cells.

5. The apparatus of claim 1, wherein, to process the control element, the one or more processors are configured to:
apply the two TCI states for the CORESET in the first serving cell; and
refrain from changing a TCI state for the CORESET in the one or more additional serving cells.

6. The apparatus of claim 1, wherein, to process the control element, the one or more processors are configured to:
discard the control element; and
refrain from changing a TCI state for the CORESET in the first serving cell and the one or more additional serving cells.

7. The apparatus of claim 1, wherein, to process the control element, the one or more processors are configured to:
apply the two TCI states for the CORESET in the first serving cell;
reconfigure the CORESET in the one or more additional serving cells for SFN transmissions; and
apply the two TCI states for the CORESET in the one or more additional serving cells.

8. An apparatus for wireless communication at a base station, comprising:
a memory; and
one or more processors, coupled to the memory, configured to:
transmit, to a user equipment (UE), a list of serving cells including a first serving cell that is using a control resource set (CORESET) for single frequency network (SFN) transmissions; and
transmit, to the UE, a control element indicating two transmission configuration indicator (TCI) states and associated with the first serving cell and the CORESET,
wherein the control element is based at least in part on one or more rules associated with the list of serving cells.

9. The apparatus of claim 8, wherein the one or more rules include a requirement that the CORESET be configured for SFN transmissions in each serving cell on the list of serving cells.

10. The apparatus of claim 8, wherein the one or more rules include a requirement that the CORESET be configured for a same type of SFN transmissions in each serving cell on the list of serving cells.

11. The apparatus of claim 8, wherein the one or more rules include a requirement that all CORESETs be configured for SFN transmissions in each serving cell on the list of serving cells.

12. The apparatus of claim 8, wherein the one or more rules include a requirement that at least one CORESET be configured for SFN transmissions in each serving cell on the list of serving cells.

13. The apparatus of claim 8, wherein the one or more processors are further configured to:
transmit, to the UE, an indication to remove at least one serving cell from the list of serving cells to comply with the one or more rules.

14. An apparatus for wireless communication at a user equipment (UE), comprising:
a memory; and
one or more processors, coupled to the memory, configured to:
receive, from a network, a control element indicating one transmission configuration indicator (TCI) state and associated with a first serving cell and a control resource set (CORESET); and
process the control element based at least in part on determining that the CORESET is used for single frequency network (SFN) transmissions in the first serving cell and is associated with two TCI states.

15. The apparatus of claim 14, wherein, to process the control element, the one or more processors are configured to:
discard the control element; and
refrain from changing the two TCI states for the CORESET in the first serving cell.

16. The apparatus of claim 14, wherein, to process the control element, the one or more processors are configured to:
change one TCI state, of the two TCI states, for the CORESET in the first serving cell, to the TCI state indicated by the control element.

17. The apparatus of claim 16, wherein, to process the control element, the one or more processors are further configured to:
change the other TCI state, of the two TCI states, for the CORESET in the first serving cell, to a default TCI state.

18. The apparatus of claim 16, wherein, to process the control element, the one or more processors are further configured to:
change a TCI state, for the CORESET in one or more additional serving cells included in a list of serving cells with the first serving cell, to the TCI state indicated by the control element.

19. The apparatus of claim 14, wherein, to process the control element, the one or more processors are configured to:
reconfigure the CORESET in the first serving cell for non-SFN transmissions; and
apply the TCI state indicated in the control element for the CORESET in the first serving cell.

20. An apparatus for wireless communication at a user equipment (UE), comprising:
a memory; and
one or more processors, coupled to the memory, configured to:
receive, from a network, a list of serving cells including a first serving cell that is using a control resource set (CORESET) for a first type of single frequency network (SFN) transmissions;
receive, from the network, a control element indicating two transmission configuration indicator (TCI) states and associated with the first serving cell and the CORESET; and
process the control element based at least in part on determining that one or more additional serving cells in the list are not using the CORESET for the first type of SFN transmissions.

21. The apparatus of claim 20, wherein, to process the control element, the one or more processors are configured to:
discard the control element; and
refrain from changing the two TCI states for the CORESET in the first serving cell.

22. The apparatus of claim 20, wherein, to process the control element, the one or more processors are configured to:
apply the two TCI states for the CORESET in the first serving cell; and
refrain from changing TCI states for the CORESET in the one or more additional serving cells.

23. The apparatus of claim 22, wherein the first serving cell is associated with a lowest or highest index for a component carrier (CC) associated with the CORESET.

24. The apparatus of claim 22, wherein the first serving cell is associated with a component carrier (CC) used to receive the control element.

25. The apparatus of claim 22, wherein the first type of SFN transmissions is associated with a majority of cells included in the list of serving cells.

26. The apparatus of claim 20, wherein first type of SFN transmissions is indicated by a bit included in the control element.

27. The apparatus of claim 20, wherein, to process the control element, the one or more processors are configured to:
apply the two TCI states for the CORESET in the first serving cell;
reconfigure the CORESET in the one or more additional serving cells for the first type of SFN transmissions; and
apply the two TCI states for the CORESET in the one or more additional serving cells.
